(19) United States
(12) Patent Application Publication
(10) Pub. No.: US 2018/0099723 A1
(43) Pub. Date: Apr. 12, 2018

(54) SUSPENSION SYSTEM FOR BICYCLES OR OTHER SIMILAR VEHICLES

(71) Applicant: Cesar Rojo Vidal, Barcelona (ES)

(72) Inventor: Cesar Rojo Vidal, Barcelona (ES)

(21) Appl. No.: 15/724,517

(22) Filed: Oct. 4, 2017

(30) Foreign Application Priority Data
Oct. 6, 2016 (ES) P201631298

(51) Int. Cl. B62K 19/18; B62K 3/02; B62M 9/00

(52) U.S. Cl. CPC B62K 19/18; B62M 9/00; B62K 3/02

(57) ABSTRACT

The present invention relates to a suspension system for bicycles or other similar vehicles, said suspension system comprising a main triangle (1) or frame connected at one end to a front wheel (6) and connected at the other end to a damper (2) and a swinging element (3) serving as support means of a rear wheel (7); and wherein it incorporates a lower connecting element (5) comprising a first connecting shaft or point (5a) connected to the main triangle (1) and a connecting shaft or point (5b) connected to the swinging element (3), and where said system incorporates an upper connecting element (4) where there is located the first connecting shaft or point (4a) connected to the main triangle (1) and another second connecting shaft or point (4b) connected to the swinging element (3) and the damper (2).

### TECHNICAL FIELD

The present specification relates to a suspension system for bicycles or other similar vehicles, the main feature of which is based on being able to reduce or eliminate the response to squat by simplifying the operation of other similar systems by means of reducing the number of shafts required.

### PRIOR ART

Bicycles and other vehicles with wheels are used today as a means of transportation or to be enjoyed in people's free time. These vehicles are essentially designed for using energy generated (by the user's legs or by a motor) by means of the driving force of one or more wheels with respect to the ground, regardless of the characteristics of the terrain where they are used.

When used on dirt paths, since there is less traction due to the irregularities in the terrain, bicycles have to have suspension means that improve the comfort and performance in usage, giving the user a feeling of greater smoothness and better traction.

These suspension systems have the main drawback of the loss of energy associated with the suspension compression and extension movement. As a result, optimally maximizing the use of energy generated in bicycles by the user by means of an optimized suspension (anti-squat) system means that the loss of this power can be reduced, and that the gains in performance are very substantial.

Solving the technical problem associated with efficiency in transmission systems of said vehicles will also simplify the tasks of the damper, thereby avoiding the use of more technically complex dampers (which include, for example, suspension locks), which will make the end product more expensive, reducing the cost-effectiveness of the marketed product.

To overcome said drawback, several solutions are known, such as the solution proposed, for example, in Spanish patent ES 2 342 347, which discloses a driven wheel suspension system comprising: a damper unit, a driven wheel, a swinging wheel carrier link, an upper carrier manipulation link, and a lower carrier manipulation link, wherein the driven wheel is rotatably attached to the swinging wheel carrier link, the swinging wheel carrier link is pivotably attached to one end of the upper carrier manipulation link and to one end of the lower carrier manipulation link, respectively, the upper carrier manipulation link and the lower carrier manipulation link are adapted to be pivotably attached at their other ends to a chassis of a vehicle in which the suspension system is used, an instant center is found by projecting individual force lines through both pivots of each of the upper and lower carrier manipulation links, and the instant center is positioned beyond the outer limits of the two pivots of the lower carrier manipulation link at zero percent suspension compression, characterized in that the instant center is positioned between said two pivots of the lower carrier manipulation link as the suspension is fully compressed.

Similarly, Spanish patent ES 2285952 comprises a suspension mechanism particularly designed for use in bicycles. The suspension mechanism uses various pivoting points linking the parts forming the structure that allows absorbing the requirements of the rear wheel support without the user noticing significant variations in chain tension. This invention uses two triangles linked by means of a four-bar linkage formed by two links and suitably linked by means of a damper in which both ends are anchored to said links.

Systems of this type tend to be complex as a result of the presence of a larger number of parts and/or articulations which considerably increase the maintenance, complexity and cost of suspension systems, which necessarily affects the cost of the vehicle in which it is installed.

### SUMMARY OF THE INVENTION

The suspension system for bicycles or other similar vehicles, object of the present specification, is characterized in that it comprises a main triangle or frame connected at one end to a front wheel and connected at the other end to a damper and a swinging element serving as support means of a rear wheel. The system incorporates a lower connecting element comprising a first connecting shaft or point connected to the main triangle and a second connecting shaft or point connected to the swinging element, and wherein said system incorporates an upper connecting element where there is located the first connecting shaft or point connected to the main triangle and another second connecting shaft or point connected to the swinging element and the damper.

The system herein proposed focuses on reducing loss of energy due to the squat of the suspension, caused by the operation of the transmission, said system producing an anti-squat response. This anti-squat response is preferably greater at the beginning of the suspension travel than at the end of the travel, where the value is lower.

Therefore, in the practical example of a bicycle which includes the suspension system proposed in the present invention, it will be possible to take maximum advantage of the anti-squat system because it will be designed to accelerate much more efficiently, with a lower loss of energy, with the frame of the vehicle in turn being more stable during acceleration forces.

To that end, the rear wheel of the bicycle will be connected to a swinging element or support unit for the rear wheel; and this will in turn be connected to the main frame of the bicycle (or main triangle) by means of two connecting elements, one in the lower portion with two pivot points and another one in the upper portion also with two pivot points.

One of these connecting elements, specifically the upper element, is fixed to the main triangle and the other connecting element will be fixed to the swinging element or support unit for the rear wheel and to the damper element. So this connecting point will share three elements (the support unit for the rear wheel, the damper element and the connecting element). Both connecting elements rotate counterclockwise when the bicycle is seen from its left side.

Throughout the description and claims the word “comprises” and its variants do not seek to exclude other technical features, additions, components or steps. For the persons skilled in the art, other objects, advantages and features of the invention will be inferred in part from the description and in part from putting the invention into practice. The following examples and drawings are provided by way of illustration and are not intended to restrict the present invention. Furthermore, the present invention covers all the possible combinations of particular and preferred embodiments herein indicated.

### DESCRIPTION OF THE DRAWINGS

A series of drawings which help to better understand the invention and which expressly relate to an embodiment of said invention presented as a non-limiting example thereof is very briefly described below.

FIG. 1 shows a diagram of the suspension system for bicycles or other similar vehicles, object of the present invention, in a non-compression state;

FIG. 2 shows the diagram shown in the preceding figure, where the suspension system is in a maximum compression state;

FIG. 3 shows a perspective view of the frame of the bicycle with the system object of the present invention;

FIG. 4 shows a detailed view of the system, where the upper connecting element system is shown;

FIG. 5 shows a side view of the frame of the bicycle, with the suspension system, in a non-compression state;

FIG. 6 shows a side view of the frame of the bicycle, with the suspension system in a maximum compression state;

FIG. 7 shows a side view of the frame of the bicycle where the compression system can be seen in a compression state of about 50%;

FIG. 8 shows a graph depicting the anti-squat response provided by the system herein described;

FIG. 9 shows a graph depicting the suspension ratio;

FIG. 10 shows a side view of a second practical embodiment of the suspension system herein presented;

FIG. 10A shows a side view of a second practical embodiment of the suspension system herein presented in a maximum compression state;

FIG. 11 shows a side view of a damper element together with an expander element of the mentioned damper, which can be used in various practical embodiments of the system herein presented;

FIG. 12 shows a top view of the elements shown in the preceding figure;

FIG. 13 shows a diagram of the suspension system in relation to the anti-squat response thereof;

FIG. 14 shows a side view of a third practical embodiment of the suspension system herein presented;

FIG. 15 shows a side view of a third practical embodiment of the suspension system herein presented in a maximum compression state;

FIG. 16 shows a side view of a fourth practical embodiment of the suspension system herein presented; and

FIG. 17 shows a side view of a fourth practical embodiment of the suspension system herein presented in a maximum compression state.

### DETAILED DISCLOSURE OF THE INVENTION

The attached drawings show a preferred embodiment of the invention. More specifically, the suspension system for bicycles or other similar vehicles, object of the present specification, is characterized in that it comprises a main triangle (1) or frame connected at one end to a front wheel (6) and connected at the other end to a damper (2) and a swinging element (3) serving as support means of a rear wheel (7), wherein said system incorporates an upper connecting element (4) where there is located the first connecting shaft or point (4a) connected to the main triangle (1) and another second connecting shaft or point (4b) connected to the swinging element (3) and the damper (2).

The lower connecting element (5) incorporates a first connecting shaft or point (5a) connected to the main triangle (1), and a second connecting shaft or point (5b) connected to the swinging element (3). Located contiguously with respect to said lower connecting element (5) there is a bottom bracket (8) serving as a pedal support.

In a preferred embodiment, the upper connecting element (4) and lower connecting element (5) will have lengths between both centers similar to one another, and they may never be more than three times the length between same.

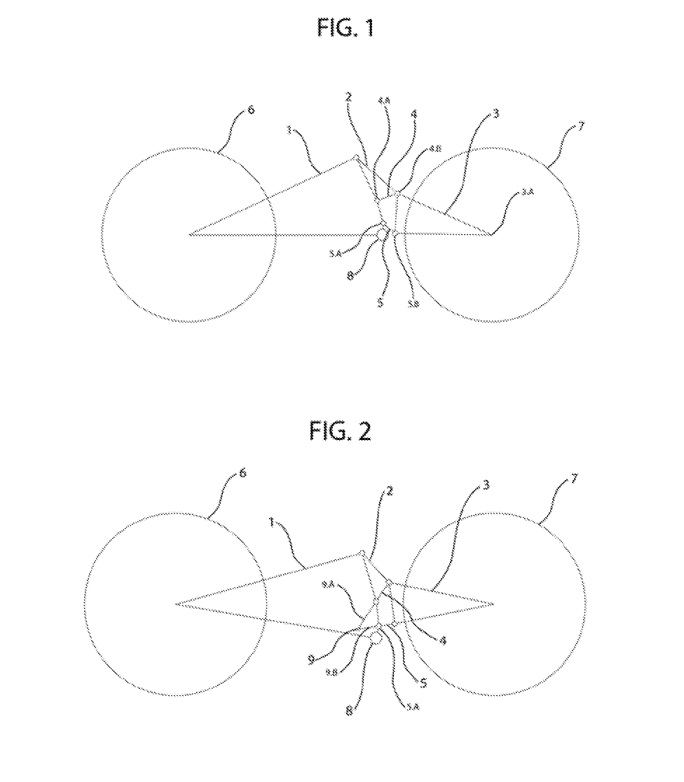

FIG. 1 perfectly shows how the upper connecting element (4) at its second connecting point (4b) shares an articulation with the swinging element (3) and damper element (2). Likewise, it can be seen how the system has only four shafts, i.e., two of the upper connecting element (4) and two of the lower connecting element (5), which means that when the wheel (7) receives an impact, said force will be transmitted to the axle of the wheel (3a) on the swinging element (3), which force will make the two connecting elements (4,5) start to move in an anti-clockwise direction, which will compress the damper (2).

FIG. 2 shows the suspension system in its maximum compression state, also known as end of run of the damper (2) or suspension stop. In said figure it can be seen how the instant center of rotation (9) of the suspension system that is generated by means of the projection of the connecting elements (4, 5) by means of respective lines (9a, 9b) does not go beyond the connecting point (5a) with the main triangle, which is an aspect that will remain unchanged in all practical cases.

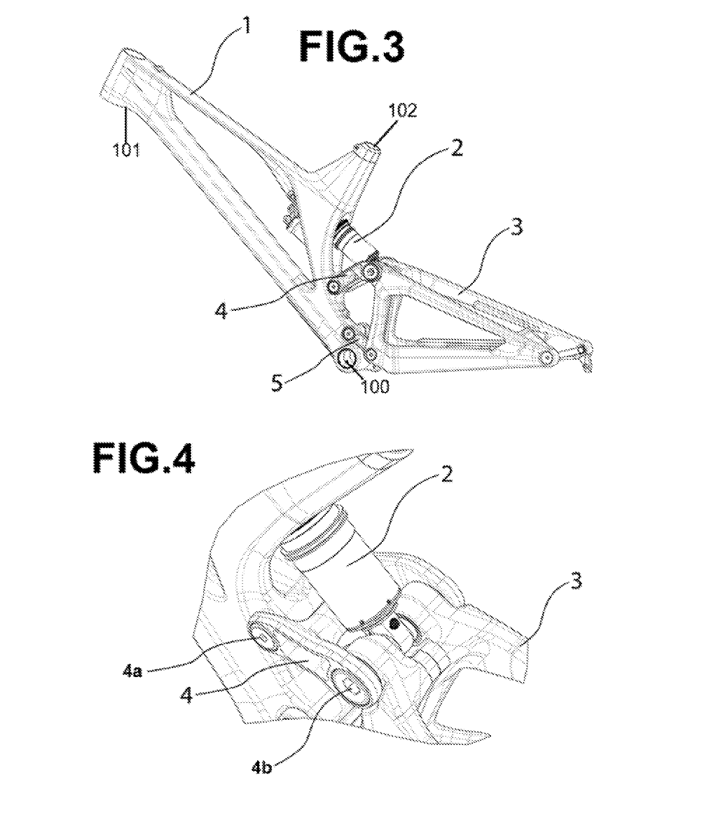

FIG. 3 shows a bicycle frame incorporating the system herein described. Said frame could be made using various materials, such as, for example, aluminum, titanium, steel, carbon fiber or others. In this specific embodiment, it can be seen that the main triangle or frame (1) will incorporate a bottom bracket (100), a steering tube (101) where a fork is connected, and a seat tube (102) where the brace of the seat will be coupled. A detail of the upper connecting element (4) and how it is connected to the damper (2) and the swinging element (3) can be seen in FIG. 4.

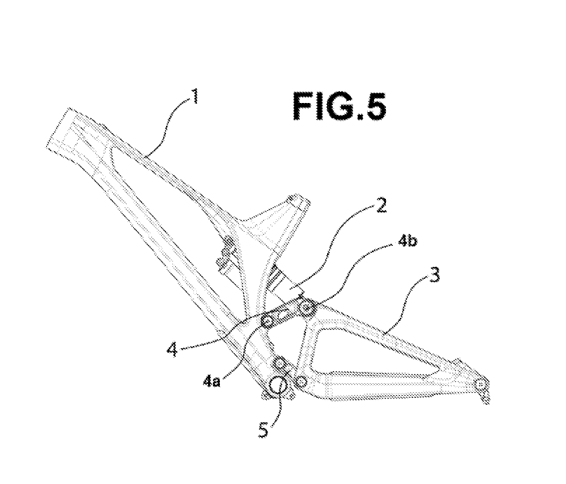

FIG. 5 shows the suspension system in idle mode with the damper (2) being fully extended. It can be seen in said figure how the damper (2), swinging element (3) and upper connecting element (4) share the same connecting point (4b).

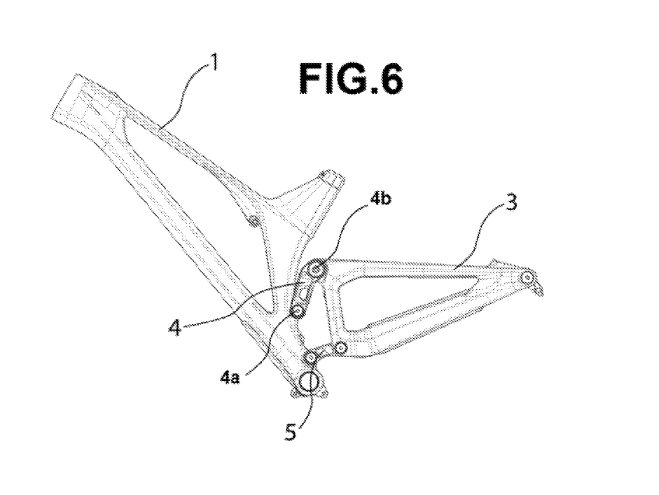

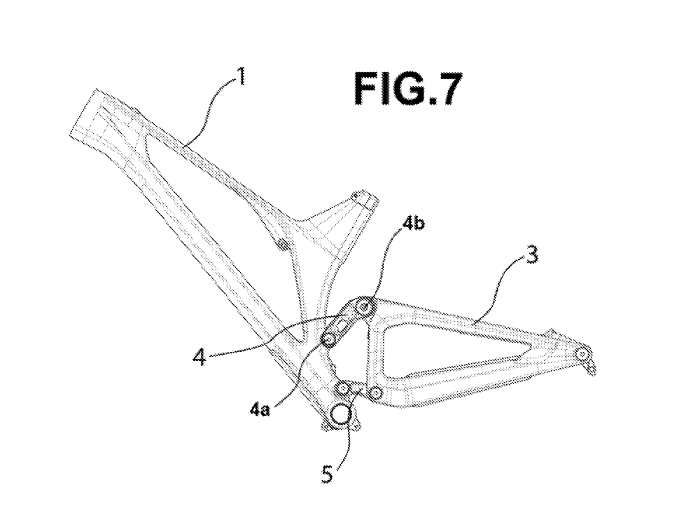

FIG. 6 shows the system with a squat of 100%, wherein in FIG. 7 the squat of the system is 50%.

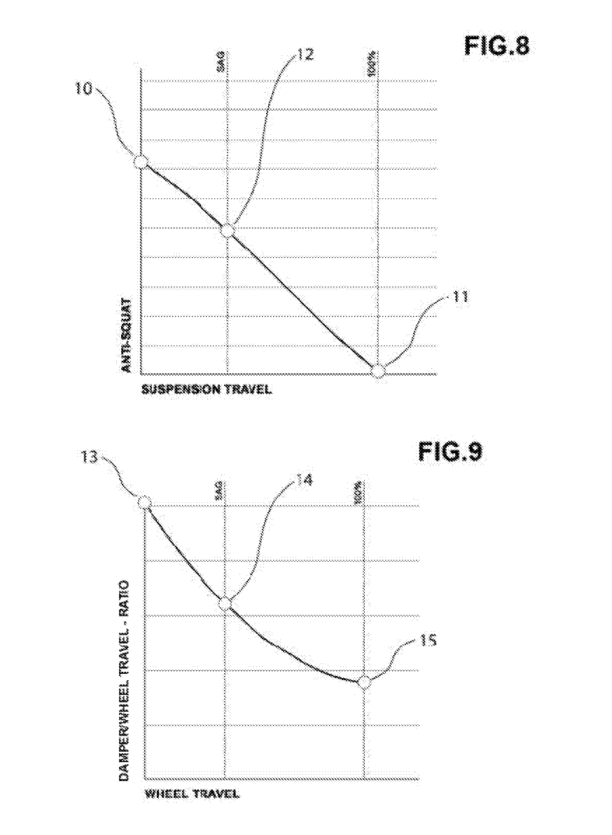

FIG. 8 shows a graph of the anti-squat response of the system, where the vertical axis represents the anti-squat percentage and the horizontal axis represents the suspension travel in the rear wheel (7). The fact that the end point (11) is always positioned below the initial point (10) can be seen in said graph. The running order point (12) represents the squat of the suspension in running order, or SAG, which also has a value lower than point (10) in all cases.

FIG. 9 shows the graph of the squat of the suspension or ratio. The vertical axis shows the ratio, which is the result of dividing travel in the rear wheel (7) by travel in the damper (2). The horizontal axis shows the suspension travel, which is the measurement of displacement of the rear shaft of the swinging element, or axle of the wheel (3a). In the suspension system of this invention and in any of its variants, the ratio at the beginning of travel (13) always has a value greater than the value of the ratio at the end of travel (15). The value of the ratio at the running order point (14) is always lower than the initial point of the beginning of travel (13).

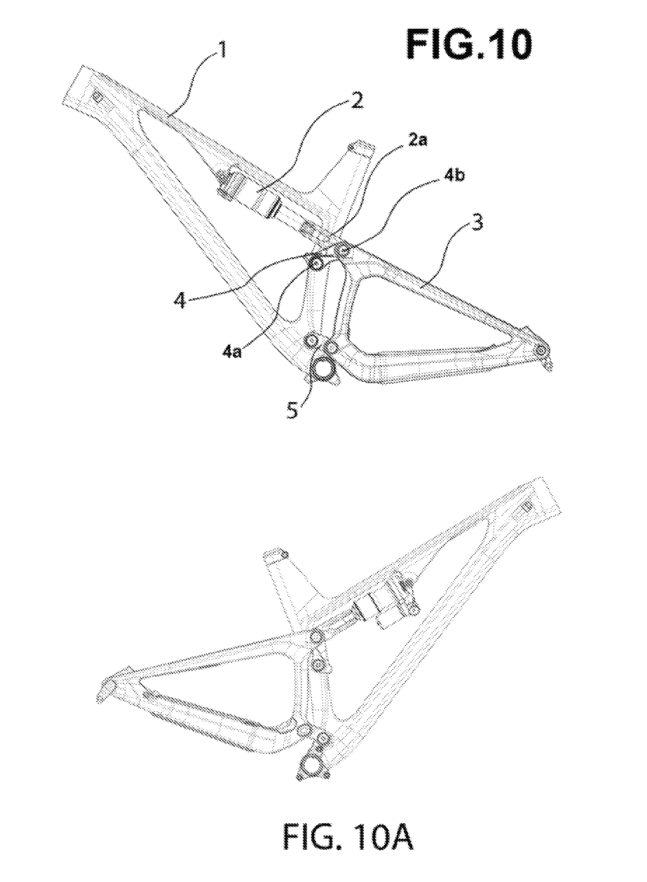

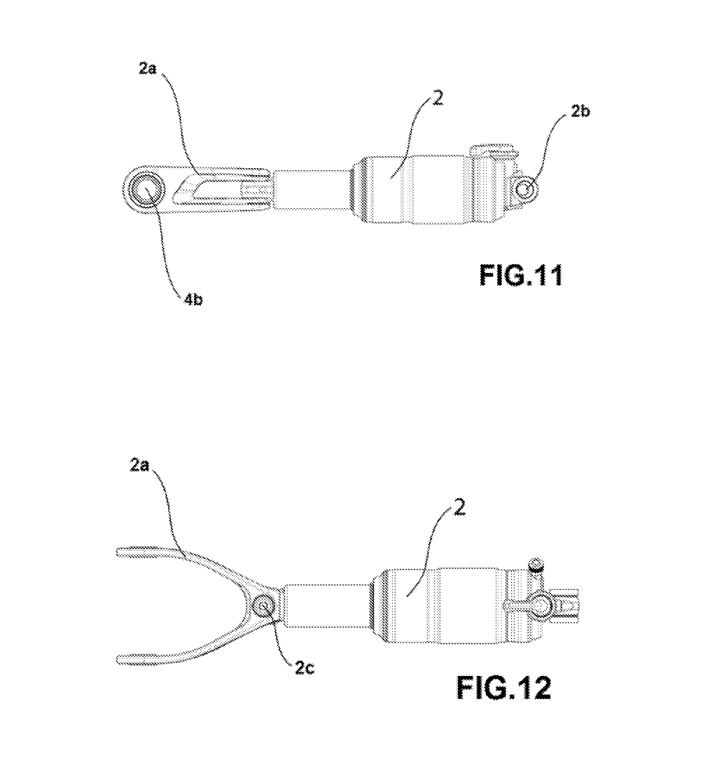

FIGS. 10, 10A, 11 and 12 show various practical embodiments of the suspension system object of the present invention, such as, for example, an embodiment where the damper (2) optionally has an expander (2a) screwed to the damper to change the length thereof if needed.

Said expander (2a) of the damper (2) is anchored at one of the ends (2b) to the main triangle (1), and at the other one of these ends, the damper (2) is anchored on the expander (2a) and connected by means of a screw (2c). The expander (2a) is connected to the swinging element (3) and upper connecting element (4) at the connecting point (4b).

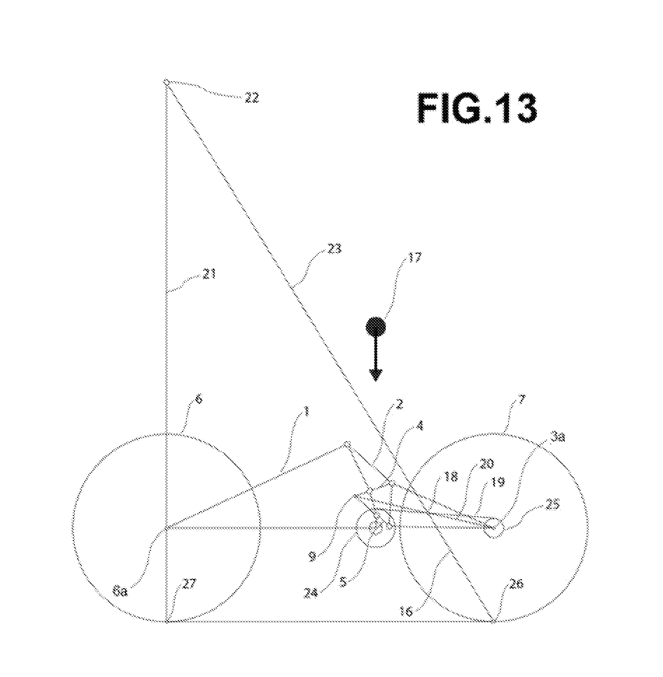

FIG. 13 shows a graph of the model for obtaining data for calculating the anti-squat response, and for thereby obtaining sufficient values to interpolate a graph such as the one shown in FIG. 8. The anti-squat system is calculated with respect to the center of masses of the system (17), which includes the weight of the vehicle and its passengers.

Several points are needed to obtain the value; on one hand there is the instant center of rotation (9) of the suspension system and on the other the chain line (19) which is obtained by means of a tangent line between the two sprockets of the vehicle, the main sprocket (24) and the secondary sprocket (25) located in the center of the rear wheel (7). The intersection of the chain line (19) with the line joining the instant center of rotation (9) and the axle of the rear wheel (3a) generates a point of intersection (18) which is used to generate the vector (23) whereby the point defining the anti-squat value (22) is ultimately generated. The vector (23) is generated by means of the projection of point (18) and point (26) generated by tangency of the rear wheel (7) with the ground. The anti-squat value (22) is generated at the intersection of vector (23) and vector (21). Vector (21) is generated by means of the line perpendicular to the ground, point (27) and the line going through the axle of the front wheel (6a). The optimal anti-squat value corresponds to the point of the anti-squat value (22) and the center of coordinates (17) of the system being aligned on the same horizontal line. This value must be calculated for the dynamic position of the vehicle. In this case, the system in idle mode has been used to exemplify how to calculate said point (22).

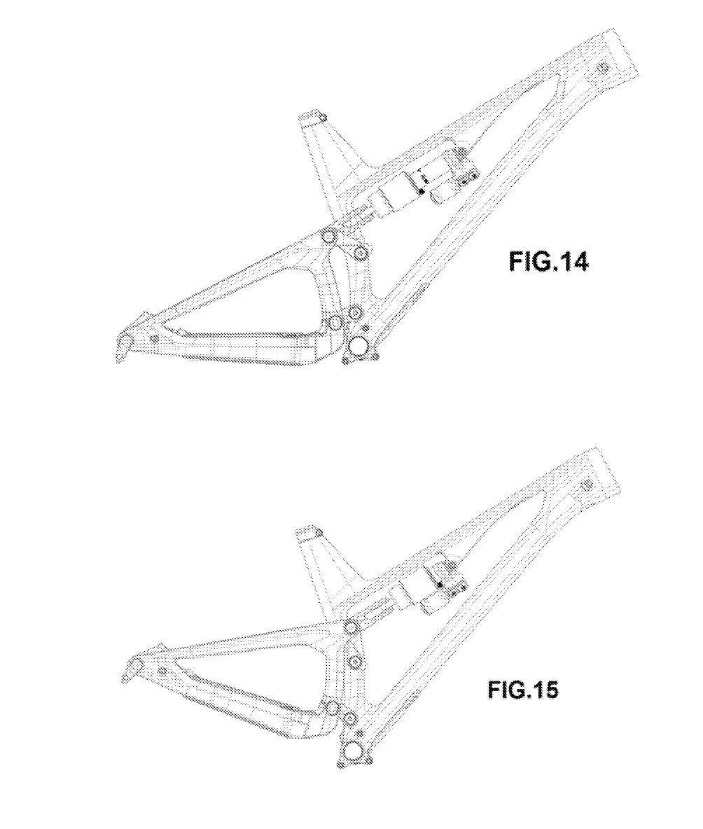

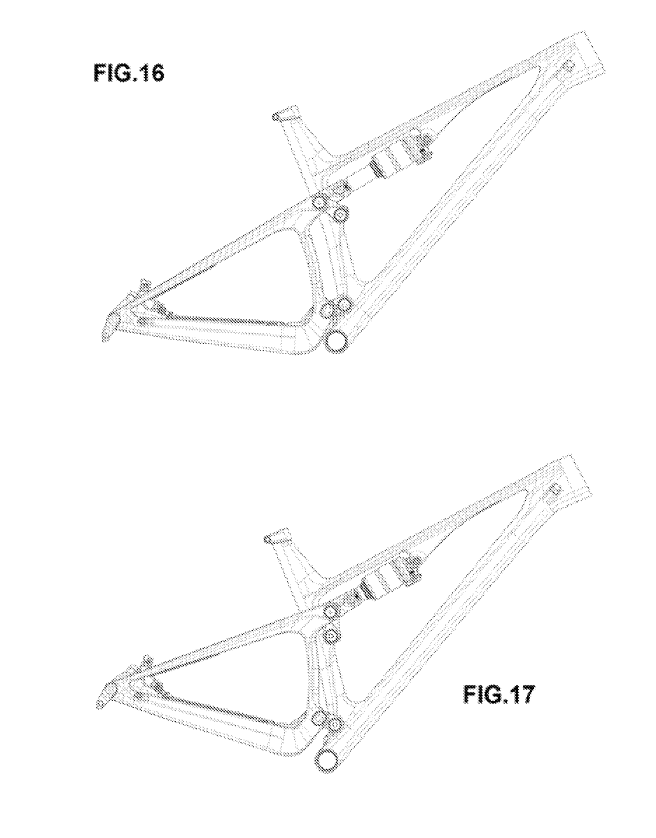

FIGS. 14, 15, 16 and 17 show various practical embodiments of the systems herein described with different suspension travels in the rear wheel, which move between 100 and 200 mm.

Finally, the system herein described will be particularly useful for vehicles incorporating a chain- or belt-driven transmission, or in human-powered vehicles.

1. A suspension system for bicycles or other similar vehicles comprising:
a main triangle (1) or frame connected at a first end to a front wheel (6) and connected at a second end to a damper (2) and a swinging element (3) serving as a support device of a rear wheel (7); and
a lower connecting element (5) comprising a first connecting shaft or point (5a) connected to the main triangle (1);
a second connecting shaft or point (5b) connected to the swinging element (3); and an upper connecting element (4) where there is located the first connecting shaft or point (4a) connected to the main triangle (1) and a second connecting shaft or point (4b) connected to the swinging element (3) and the damper (2).

2. The system according to claim 1, wherein located contiguously with respect to said lower connecting element (5) there is a bottom bracket (8) serving as a pedal support.

3. The system according to claim 1, wherein an instant center of rotation (9) of the suspension system that is generated by the projection of the connecting elements (4, 5) does not go beyond the connecting point connected to the main triangle (5a).

4. The system according to claim 1, wherein an anti-squat curve has an initial value (10) greater than a final value (11).

5. The system according to claim 1, wherein a anti-squat curve has an initial value (10) greater than a running order value (12).

6. The system according to claim 1, wherein a anti-squat curve has a value at the running order point (12) greater than a final value (11).

7. The system according to claim 1, wherein a curve of a ratio of the damper and the wheel travel has an initial value (13) greater than a final value (15).

8. The system according to claim 1, wherein a curve of a ratio of the damper and the wheel travel has a running order value (14) greater than a final value (15).

9. The system according to claim 1, wherein the damper (2) incorporates an expander (2a).

10. The system according to claim 1, wherein the connecting elements (4, 5) rotate in the same direction.

11. The system according to claim 1, wherein the upper connecting element (4) and lower connecting element (5) have lengths between both centers similar to one another and never more than three times the length between same.

12. The system according to the preceding claims, wherein said system is part of a vehicle with a chain-driven transmission.

13. The system according to claim 1, wherein said system is part of a vehicle with a belt-driven transmission.

14. The system according to claim 1, wherein said system is part of a human-powered vehicle.
